(19) United States
(12) Patent Application Publication
(10) Pub. No.: US 2011/0157651 A1
(43) Pub. Date: Jun. 30, 2011

(54) IMAGE FORMING APPARATUS AND CONTROL METHOD THEREOF

(75) Inventor: Masaru OHTSUKA, Tokyo (JP)

(73) Assignee: KONICA MINOLTA BUSINESS TECHNOLOGIES, INC., Tokyo (JP)

(21) Appl. No.: 12/968,941

(22) Filed: Dec. 15, 2010

(30) Foreign Application Priority Data
Dec. 25, 2009 (JP) 2009-295685

(51) Int. Cl. G06K 15/00

(52) U.S. Cl. 358/1.16

(57) ABSTRACT

An image forming apparatus including a replaceable image forming unit for yellow and others mounted on a photocopier body to share the load of implementing image forming output functions for each color; a memory section on the apparatus body side for storing information of the image forming unit for yellow and others; an operation display section for setting a plurality of body memory areas for unit management to the memory section; and a control section for controlling the image forming unit for yellow as a replaceable spare part for the image forming unit for yellow and others as a regularly installed part, and for processing unit information for each image forming unit for yellow, using a plurality of body memory areas of the set memory section.

This application is based on Japanese Patent Application No. 2009-295685 filed on Dec. 25, 2009 with Japanese Patent Office, the entire content of which is hereby incorporated by reference.

### BACKGROUND OF THE INVENTION

The present invention relates to an image forming apparatus and control method thereof which are applicable to a color copier, multi-functional peripheral, printer and others equipped with a plurality of replaceable function implementation units which are mounted on the apparatus body and are capable of implementing the image forming output function.

In recent years, there have been a growing number of cases of using a color copier, multi-functional peripheral, printer and others equipped with a plurality of replaceable function implementation units which are mounted on the apparatus body and are capable of implementing the image forming output function. For example, a digital color copier for forming color images based on the document image data of the red (R), green (G) and blue (B) system read out of a document has been widely put into practical use.

According to this type of color copier, a color document image is read by a scanner and others, and the document image data related to that document image is once stored in an image memory. After that, the document image data read out of the image memory is subjected to image processing and the document image data having been subjected to image processing is transferred to a color printer.

The color printer using electrophotographic process is provided with an image forming section for forming a color toner image based on the image data for yellow (Y), magenta (M), cyan (C) and black (BK) subsequent to color conversion of the document image data of the RGB system. The image forming section is provided with image forming units for sharing the load of implementing the image forming output function for Y, M, C and BK colors. By the scanning exposure section using a polygon mirror and others, an electrostatic latent image is formed on a photoreceptor drum uniformly charged by a charging device based on the document image data for each image forming color.

This electrostatic latent image is developed by the developing device for each image forming color. The color toner images formed on the photoreceptor drum by such charging, exposure and development operations are superimposed, for example, on an intermediate transfer belt. The color toner images superimposed in this position are transferred onto a transfer material by a transfer section. The toner image transferred to a prescribed transfer material is fixed by the fixing section, with the result that the color image based on the document image data can be formed on a prescribed transfer sheet and the document image can be copied.

The user wishing to perform forming output (print) of the color image on a great number of transfer sheets on a continuous basis prepares a plurality of image forming units as spare parts for the image forming unit as a regularly installed part. For example, when there is an increase in the number of times the image forming unit as the regularly installed part has been used, use of the image forming unit of the regularly installed part is changed to the use of the image forming unit of a spare part, in conformity to the number of times the part has been used.

In connection with the image forming apparatus of this type sharing the load of implementing the image forming output function by changing the image forming units, Unexamined Japanese Patent Application Publication No. 2005-115157 (FIG. 5 on page 7) discloses an image forming apparatus, the unit thereof and the information management method thereof. This image forming apparatus is provided with an apparatus body, body storage section, detachable unit, unit storage section, reading device, updating device, writing device and determination device. The body storage section is mounted on the apparatus body and stores the information read from the detachable unit. The detachable unit is structured to be mounted and dismounted from the apparatus body. The unit storage section is mounted on this unit to store information. The reading device reads the information inside the unit storage section into the body storage section.

The updating device updates the information inside the body storage section. The writing device writes the information inside the body storage section into the unit storage section. Before the information inside the body storage section is written into the unit storage section, the determination device determines whether or not writing should be performed, based on the information in the body storage section and information in the unit storage section. On the premise of this, the determination device determines if writing should be performed or not, based on the decision on whether or not the information inside the body storage section corresponds with that inside the unit storage section. To be more specific, if there is no agreement between the information in the body storage section and that in the unit storage section, writing of information is rejected. When an image forming apparatus is structured in this manner, the unit can be prevented from being used in excess of the original life span. Quick formation of an image is provided without unwanted information being read.

Incidentally, the image forming apparatus in the conventional example has the following problems:

i. In the image forming apparatus disclosed in Unexamined Japanese Patent Application Publication No. 2005-115157 (FIG. 5 on page 7), when managing the units that can be replaced on the apparatus body, a step is taken to determine whether writing should be performed or not, depending on whether or not agreement can be found between the information in the body storage section and that in the unit storage section. If there is no agreement between the information in the body storage section and that in the unit storage section, the writing of information is rejected.

This involves the problem wherein, despite agreement between the information in the body storage section and that in the unit storage section, writing of information will fail, when correct writing of the information of the unit has failed due to communication error, writing error or momentary interruption of the main power supply before prescribed timing is reached, and when a discrepancy has occurred between the information in the body storage section and that in the unit storage section at the time of power recovery.

ii. When correct writing of the information of the unit has failed due to communication error, writing error or momentary interruption of the main power supply before prescribed timing is reached, and when a discrepancy has occurred between the information in the body storage section and that in the unit storage section, incorrect information may be written to indicate, for example, that the life span has not yet reached, despite the fact that the life span of the function implementation unit has already been passed due to the discrepancy of information. This will give an adverse effect to the unit management, and will disable secure management of the life span of the parts constituting the image forming unit.

iii. In the image forming apparatus disclosed in Unexamined Japanese Patent Application Publication No. 2005-115157 (FIG. 5 on page 7), when managing a plurality of function implementation units that can be replaced on the apparatus body, the memory area in the body storage section is not correlated with each of the function implementation units. This makes it difficult to ensure smooth and secure management of the life span of two or more function implementation units that can be replaced on the image forming unit and that shares the load of implementing the same image forming output function. Moreover, the life span is not managed in units of the parts constituting the function implementation unit. This increases the downtime in the apparatus body when the parts constituting the function implementation unit are replaced.

In view of the problems described above, it is an object of the present invention to provide an image forming apparatus and control method thereof characterized by ensuring smooth and secure management of a plurality of memory areas for unit management and two or more replaceable function implementation units for one image forming function, and minimizing the downtime of the apparatus body when replacing the parts constituting the function implementation unit.

### SUMMARY

To achieve at least one of the aforementioned objects, the image forming apparatus reflecting one aspect of the present invention has the following.

In other words, to solve at least one of the problems, the image forming apparatus of the Structure 1 includes a replaceable function implementation unit mounted on the apparatus body to share the load of implementing the image forming output function; a storage section on the apparatus body side provided with a memory area for storing information of the function implementation unit; a setting section for setting a plurality of memory areas for unit management in the memory area of the storage section; and a control section for controlling the writing of information for each function implementation unit, using a plurality of memory areas of the storage section having been set by the setting section.

According to the image forming apparatus of Structure 1, the function implementation unit is mounted on the apparatus body to share the load of implementing the image forming output function. The storage section has a memory area, which stores the information on the function implementation unit. The setting section sets a plurality of memory areas for unit management in the memory area of the storage section. Under this condition, the control section controls the writing of information for each function implementation unit, using a plurality of memory areas of the storage section set by the setting section. The information writing control ensures smooth and secure management of a plurality of memory areas for unit management provided on the storage section and two or more replaceable function implementation units for the image forming output function to be implemented in apparatus body.

The image forming apparatus of Structure 2 is characterized with respect to that of Structure 1 in that the aforementioned function implementation unit includes a storage section on the unit side for storing the identification information for identifying the function implementation unit, and the information on the number of times of use including the number of times the parts constituting the function implementation unit have been used, and a first information writing device for writing information from the storage section on the unit side to the storage section on the apparatus body side at prescribed time. The control section has a second information writing device for writing information from the storage section of the apparatus body to the storage section on the unit side at prescribed time.

The image forming apparatus of Structure 3 is characterized with respect to that of Structure 2 in that the aforementioned time when the first information writing device writes information into the storage section on the apparatus body side is when power is supplied to the apparatus body or when the unit is mounted.

The image forming apparatus of Structure 4 is characterized with respect to that of Structure 3 in that the information stored in the storage section on the apparatus body side includes the information on the number of times each part has been used, and a control section is provided to determine whether the information on the number of times of use for each part has been reset or not, and to control the first information writing device based on the result of decision. If the information on the number of times of use for each part has been reset, the control section controls the first information writing device to write the information on the number of times each part has been used, into the storage section on the apparatus body side.

The image forming apparatus of Structure 5 is characterized with respect to that of Structure 2 in that the aforementioned time when the second information writing device writes information into the storage section on the unit is the time when power supply to the apparatus body is cut off, when a prescribed number of sheets have been printed, when the unit replacement operation has been started, or when the life span of parts has expired.

The image forming apparatus of Structure 6 is characterized with respect to that of Structure 1 in that the control section has a determination device, and the determination device determines whether or not information should be written from the storage section of the unit side to the storage section on the apparatus body side, based on the identification information and the information on the number of times of use.

The image forming apparatus of Structure 7 is characterized with respect to that of Structure 1 in that the control section has a memory selection device, and the memory selection device selects from a plurality of memory areas set in the storage section in association with each identification information of the function implementation unit.

The image forming apparatus of Structure 8 is characterized with respect to that of Structure 7 in that the information stored in the storage section includes the information on the replacement date of the function implementation unit and the control section determines whether a plurality of memory areas set to the storage section have all been used or not, and whether the identification information of the function implementation unit not present in any of the memory areas has been read or not. Based on the result of decision, the control section controls the memory selection device in such a way as to select the memory area storing the information of the function implementation unit whose replacement date is the oldest.

The control method of the image forming apparatus of Structure 9 is characterized in that the image forming apparatus that allows replacement of the function implementation unit mounted on the apparatus body to share the load of implementing the image forming output function executes a step of setting a plurality of memory areas for unit management in the memory area provided on the apparatus body, and a step of controlling the writing of information for each function implementation unit using a plurality of memory areas having been set.

### BRIEF DESCRIPTION OF THE DRAWINGS

FIG. 1 is a conceptual diagram showing the structural example of a color copier 100 as an embodiment of the present invention.

FIG. 2 is a block diagram showing the structural example of a color copier 100 control system.

FIG. 3 is an explanatory diagram showing an example of contents of unit information Du.

FIG. 4 is an explanatory diagram showing a usage example of the body memory area on the apparatus body side.

FIG. 5 is an explanatory diagram showing a setting example (No. 1) of the body memory area on the apparatus body side.

FIG. 6 is an explanatory diagram showing a setting example (No. 2) of the body memory area on the apparatus body side.

FIG. 7 is an explanatory diagram showing a setting example (No. 3) of the body memory area on the apparatus body side.

FIG. 8 is an explanatory diagram showing an updating example (No. 1) of the body memory area on the apparatus body side.

FIG. 9 is an explanatory diagram showing an updating example (No. 2) of the body memory area on the apparatus body side.

FIG. 10 is an explanatory diagram showing a setting example (No. 4) of the body memory area on the apparatus body side.

FIG. 11 is an explanatory diagram showing a setting example (No. 5) of the body memory area on the apparatus body side.

FIG. 12 is a flow chart showing an example of unit information writing control (No. 1) in the color copier 100.

FIG. 13 is a flow chart showing an example of unit information writing control (No. 2).

FIG. 14 is a flow chart showing an example of unit information writing control (No. 3).

FIG. 15 is a flow chart showing an example of unit information writing control (No. 4).

### DETAILED DESCRIPTION OF THE PREFERRED EMBODIMENT

Referring to the drawings, the following describes the image forming apparatus and control method thereof related to embodiments of the present invention.

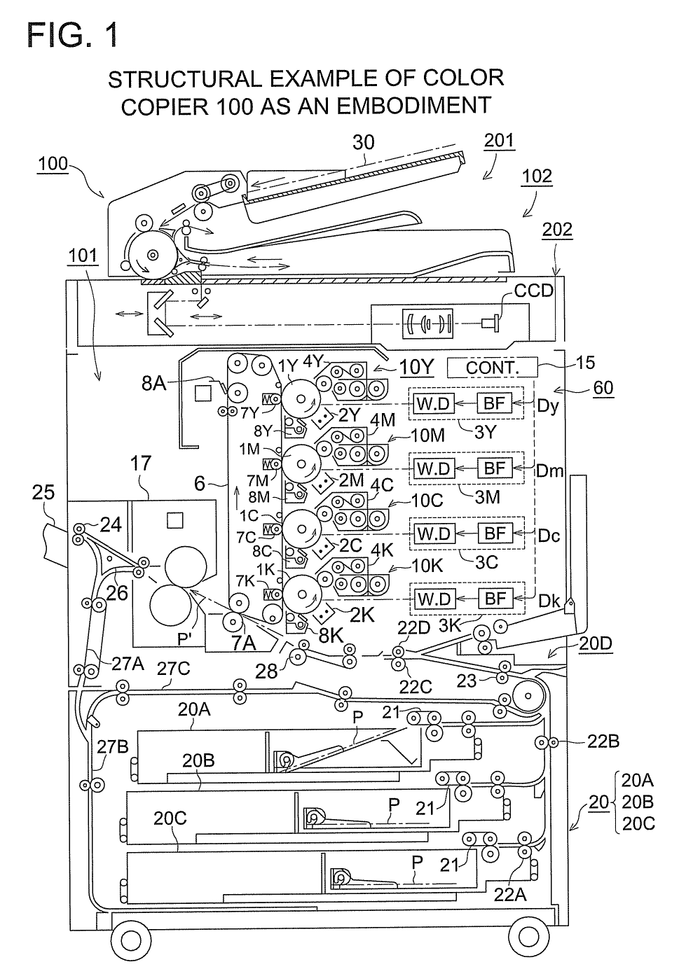

The color copier 100 of FIG. 1 is an example of the image forming apparatus, and is capable of forming the color image made up of at least two colors on a continuous basis. The color copier 100 includes an image forming section 60 and a fixing device 17 as examples of the function implementation unit. They share the load of implementing the image forming output function for color images on a photocopier body 101 (also referred to as “apparatus body side”). The image forming section 60 is unitized for each one of image forming colors. For example, the image forming section 60 includes four image forming units 10Y, 10M, 100 and 10K for yellow (Y), magenta (M), cyan (C) and black (BK), respectively. The image forming units 10Y, 10M, 100 and 10K are structured in such a way that they can be mounted on the photocopier body 101 and can be replaced in order to implement the image forming output function.

The color copier 100 is made up of the photocopier body 101 and an image reading device 102. The image reading device 102 is installed on the upper portion of the photocopier body 101, and includes an automatic document feed apparatus 201 and a document image scanning exposure apparatus 202. A colored document 30, for example, placed on the document platen of the automatic document feed apparatus 201 is conveyed by a conveyance section (not illustrated).

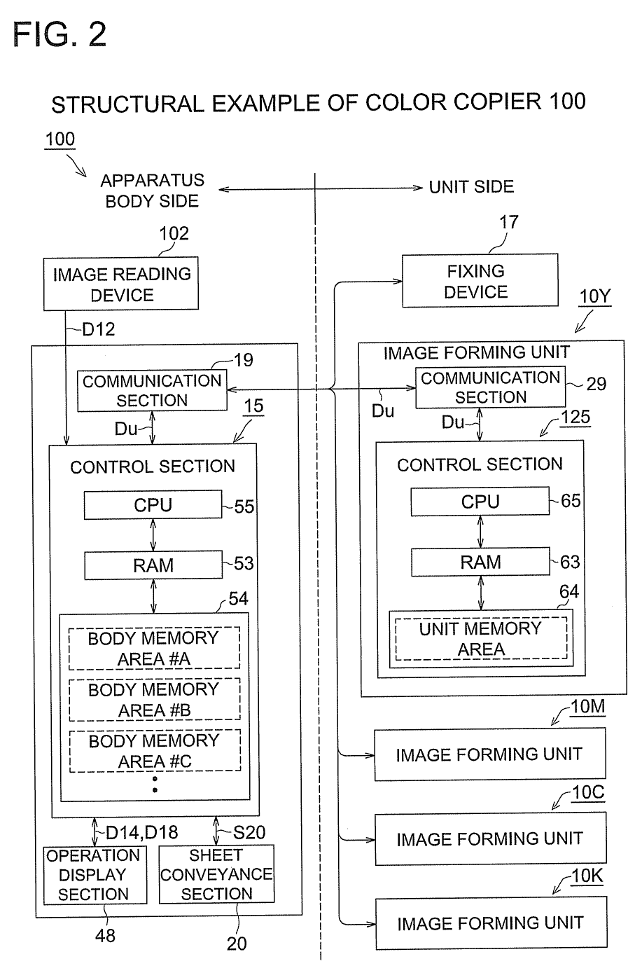

The image on one or both surfaces of the document 30 is scanned and exposed to light by the optical system of the document image scanning exposure apparatus 202. The incident light reflecting the color document image is read by a line image sensor CCD. The analog image signal for colors subjected to photoelectric conversion by the line image sensor CUD undergoes analog processing, analog-to-digital conversion, shading correction and image compression processing in the image reading device 102, and is formed into digital color image data D12 (FIG. 2).

The photocopier body 101 constitutes a tandem type color image forming apparatus, and is provided with an endless intermediate transfer belt 6, secondary transfer roller 7A, image forming units 10Y, 10M, 10C and 10K, fixing device 17 and sheet conveyance section 20. The image forming units 10Y, 10M, 10C and 10K constitutes an image forming section 60 (printer).

The image forming unit 10Y for forming a yellow toner image is unitized and is provided with a photoreceptor drum 1Y, charging device 2Y, image writing section 3Y, developing device 4Y and cleaning section 8Y for yellow color. In this example, a cleaning section 8Y, charging device 2Y, image writing section 3Y and developing device 4Y are arranged around the photoreceptor drum 1Y in the counter clockwise direction with the intermediate transfer belt 6 as a reference.

The photoreceptor drum 1Y is rotatably arranged in close proximity to the intermediate transfer belt 6. The electrostatic latent image based on the image data Dy for yellow image formation is written onto the photoreceptor drum 1Y. An organic photo conductor (OCP) drum is used as the photoreceptor drum 1Y. The charging device 2Y is installed at the specified position of the outer periphery on the photoreceptor drum 1Y. The charging device 2Y charges the photoreceptor drum 1Y at a prescribed potential level.

In this example, a beam optical path is provided between the charging device 2Y and developing device 4Y, and the image writing section 3Y is arranged at the position opposed to the photoreceptor drum 1Y. The image writing section 3Y allows the photoreceptor drum 1Y to be exposed to the beam according to the image data Dy for yellow image formation.

The image writing section 3Y includes a device buffer 31 (BF) and writing device 32 (WD). The device buffer 31 temporarily stores the image data Dy which is supplied from a control section 15 to the image writing section 3Y. A RAM is used as the device buffer 31.

The device buffer 31 is connected with the writing device 32, which generates a laser beam according to the image data Dy and expose the photoreceptor drum 1Y to the beam. The writing device 32 uses a polygon mirror scanning type laser beam writing unit in which laser beam scanning is performed by a polygon mirror, and an LD printer head (LPH) in which laser diode elements are arranged in a line to provide collective exposure.

The developing device 4Y is arranged between the intermediate transfer belt 6 and image writing section 3Y at a specific position on the outer periphery of the photoreceptor drum 1Y. The development bias formed by superimposition of AC voltage to DC voltage having the same phase (negative phase in the present embodiment) as that of the toner is applied to the developing device 4Y so that reversed development is performed. Receiving the development bias, the developing device 4Y uses the yellow toner member to develop the electrostatic latent image written on the photoreceptor drum 1Y.

The yellow toner image having been developed is transferred from the photoreceptor drum 1Y to the intermediate transfer belt 6 (primary transfer). The yellow toner image is superimposed on the toner images of other colors on the intermediate transfer belt 6 and is converted into a color toner image. The cleaning section 8Y is installed between the intermediate transfer belt 6 and charging device 2Y at a specific position on the outer periphery of the photoreceptor drum 1Y. The cleaning section 8Y removes the toner remaining on the photoreceptor drum 1Y subsequent to primary transfer.

Below the aforementioned photoreceptor drum 1Y, image forming units 10M, 10C and 10K are arranged along the intermediate transfer belt 6. The image forming unit 10M for forming a magenta toner image includes a photoreceptor drum 1M, charging device 2M, image writing section 3M, developing device 4M and cleaning section 8M for magenta. The image forming unit 10C for forming a cyan toner image includes a photoreceptor drum 1C, charging device 2C, image writing section 3C, developing device 4C and cleaning section 8C for cyan.

The image forming unit 10K for forming a black toner image includes a photoreceptor drum 1K, charging device 2K, image writing section 3K, developing device 4K and cleaning section 8K for black. For the description of the internal structure and function of the image forming units 10M, 10C and 10K, the aforementioned image forming unit 10Y can be referred by reading “Y” as “M”, “C” or “BK”.

The intermediate transfer belt 6 arranged so that it can be brought into contact with photoreceptor drums 1Y, 1M, 1C and 1K is wound around a plurality of rollers, and is held rotatably. The yellow, magenta, cyan and black toner images formed on the photoreceptor drums 1Y, 1M, 1C and 1K are transferred onto the intermediate transfer belt 6 (primary transfer). A secondary transfer roller 7A is installed below the intermediate transfer belt 6. The secondary transfer roller 7A allows the color toner image superimposed on the intermediate transfer belt 6 to be transferred onto a prescribed sheet P (secondary transfer). The sheet P on which the color toner image has been transferred is also called a transfer sheet P′.

The fixing device 17 is arranged adjacent to the aforementioned secondary transfer roller 7A. The fixing device 17 is unitized and is used to fix the color image secondarily transferred onto the sheet P. The fixing device 17 is provided with such components (not illustrated) as a fixing roller, pressure roller, heater (IH), and fixing cleaning section. In the fixing process, heat and pressure are applied to the transfer sheet P′ when the transfer sheet P′ is passed through the fixing roller heated by a heater and pressure roller. The transfer sheet P′ with the color image fixed thereon is sandwiched between the sheet ejection rollers 24 and is ejected onto the sheet ejection tray 25 outside the apparatus.

In this example, a cleaning section 8A is mounted on the upper left of the intermediate transfer belt 6, and is used to remove the toner agent remaining on the intermediate transfer belt 6 subsequent to transfer operation. The cleaning section 8A has a discharging section (not illustrated) for discharging the intermediate transfer belt 6 and a pad for removing the toner remaining on the intermediate transfer belt 6. The belt surface is cleaned by this cleaning section 8A, and the intermediate transfer belt 6 having been discharged by the discharging section enters the next image forming cycle.

A sheet conveyance section 20 is mounted below the aforementioned image forming section 60 (image forming system), and is used to feed (or conveys) the sheet P to the image forming section 60. The sheet conveyance section 20 is provided with three sheet feed trays 20A, 20B and 20C, for example. In this example, the sheet P fed out of the sheet conveyance section 20 is conveyed to a position below the image forming unit 10K and below the intermediate transfer belt 6 (secondary transfer position). Conveyance rollers 22A, 22B, 22C and 23, loop roller 22D, and registration roller 28 are mounted along the sheet conveyance path 20D leading from the sheet conveyance section 20 to a position below the image forming unit 10K.

Referring to FIG. 2, the following describes an example of the structure of the control system of a color copier 100. The color copier 100 of FIG. 2 includes a control section 15, communication section 19, sheet conveyance section 20, operation display section 48 and image reading device 102 provided on the apparatus body side. The color copier 100 further includes image forming units 10Y, 10M, 10C and 10K and fixing device 17 provided on the unit side. The control section 15 includes a work memory (Random Access Memory, hereinafter referred to as “RAM 53”) that allows writing and reading of the information whenever required, a memory section 54, and a central processing unit (hereinafter referred to as “CPU 55”).

The CPU 55 is connected with the RAM 53 for work memory. The RAM 53 is connected with a memory section 54 which constitutes an example of the storage section on the apparatus body side. The memory section 54 has a memory area to store the unit information Du of the image forming units 10Y, 10M, 10C and 10K. This unit information Du includes the information on the number of times the part has been used for each part. For example, it includes the information on the number of times the part has been used such as the photoreceptor drum 1Y, charging device 2Y, image writing section 3Y, developing device 4Y and cleaning section 8Y for yellow constituting the image forming unit 10Y.

In this example, the memory area of the memory section 54 contains a plurality of memory areas for unit management for each of the image forming units, which implements image forming function in each color. For example, the image forming unit 10Y for implementing the yellow image forming function is provided with three memory areas for unit management (hereinafter referred to as “body memory areas #A, #B and #C). The image forming units 10M, 10C and 10K for implementing the magenta, cyan and black image forming functions are also provided with the equivalent areas.

It goes without saying that the memory section 54 is loaded with a system program for controlling the photocopier as a whole, a writing acceptable/unacceptable determination program, a body memory area selection program, and control information for writing control in the image writing section 3Y and others. The memory section 54 contains such nonvolatile memories as a read only memory (ROM), EEPROM, and hard disk drive (HDD). For example, when the power has been turned on, the CPU 55 having detected the power ON information reads the system program out of the ROM of the memory section 54, and develops it on the RAM 53. Then the system is started and the photocopier as a whole is controlled.

The control section 15 is connected with an operation display section 48. The operation display section 48 constitutes an example of the setting section. A plurality of body memory areas #A, #B and #C for unit management are set on the memory area of the memory section 54. The operation display section 48 is made up of an operation section and display section (not illustrated). The operation display section 48 includes a touch panel and a liquid crystal display panel. The operation display section 48 uses a GUI (Graphical User Interface) type input device.

It goes without saying that the operation display section 48 is operated to select the image forming conditions and sheet feed trays 20A through 20C. For example, the operation display section 48 is operated to select the type and size of the sheet P, and one of the sheet feed trays 20A through 20C for storing the sheets P. Then the image forming conditions are set. The image forming conditions and sheet feed tray selection information having been set by the operation display section 48 are turned into the operation data D14 which is outputted to the control section 15. The image forming conditions and others are displayed on the display section according to the display data D18. The display data D18 is outputted from the control section 15 to the operation display section 48.

Using a plurality of body memory areas #A, #B and #C of the memory section 54 set by the operation display section 48, the control section 15 processes the unit information Du on the yellow image forming unit 10Y that can be replaced on the photocopier body 101.

The image forming unit 10Y has a control section 125 and communication section 29 provided on the unit side. The control section 125 includes a RAM 63, memory section 64 and CPU 65. The memory section 64 is loaded with an identification information ID for identifying the image forming unit 10Y, and the information on the number of times each part has been used, including the information on the number of times (Nx) the parts constituting the image forming unit 10Y have been used.

The unit memory area is set on the memory section 64, and is loaded with the description of the information on the number of times the part has been used, including the information on the number of times (Nx) the parts constituting the image forming unit 10Y have been used, such as the photoreceptor drum 1Y, charging device 2Y, image writing section 3Y, developing device 4Y and cleaning section 8Y for yellow. The CPU 65 and the RAM 63 for work memory constitutes the first information writing device, and is used to write the unit information Du onto the memory section 54 on the apparatus body side from the memory section 64 on the unit side at prescribed time.

In this example, the time when the RAM 63 and CPU 65 constituting the first information writing device write the unit information Du onto the memory section 54 on the apparatus body side is when power is supplied to the apparatus body or when the unit is mounted. This is intended to know the information on the number of times the part has been used for each part when power is supplied to the image forming unit 10Y and others or when the unit is mounted, on the apparatus body side.

When the image forming unit 10Y is structured in this manner, the unit information Du can be written from the memory section 64 on the unit side to the memory section 54 on the apparatus body side by the RAM 63 and CPU 65 on the unit side when power is supplied or when the unit is mounted.

Further, the CPU 65 determines whether or not a step has been taken to reset the information on the number of times the part has been used for each part such as the photoreceptor drum 1Y, charging device 2Y, image writing section 3Y, developing device 4Y or cleaning section 8Y for yellow constituting the image forming unit 10Y. Based on the result of this determination, the CPU 65 controls the writing of information of the RAM 63. If a step has been taken to reset the information on the number of times each part has been used, the CPU 65 controls the RAM 63 so that information on the number of times the part has been used for each part is written to the memory section 54 on the apparatus body side.

If writing in the RAM 63 is controlled in the aforementioned manner, the information on the number of times the part has been used for each part such as the yellow photoreceptor drum 1Y, charging device 2Y, image writing section 3Y, developing device 4Y or cleaning section 8Y for yellow can be written to the memory section 54 on the apparatus body side, even if writing of the unit information Du has been disabled for some reason.

The aforementioned control section 125 is connected with the communication section 29. The communication section 29 is connected with the communication section 19 on the apparatus body side, and performs communication processing under the control of the CPU 65 when the unit information Du is written to the memory section 54 on the apparatus body side. For the magenta, cyan and black image forming units 10M, 10C and 10K, the unit information Du is also processed in the similar manner.

In the meantime, the CPU 55 on the apparatus body side provides an example of the second information writing device. The unit information Du is written to the memory section 64 on the unit side from the memory section 54 on the apparatus body side at prescribed time. For example, the time when the CPU 55 writes the unit information Du to the memory section 64 on the unit side is the time when power supply to the apparatus body is cut off, when a prescribed number of sheets are printed, when the unit replacement operation has started, or when the life span of a part has expired. This is intended to enable the image forming unit 10Y to know the information on the number of times the part has been used for each part, when power supply to the apparatus body is cut off, when a prescribed number of sheets are printed, when the unit replacement operation has started, or when the life span of parts has expired.

As described above, a CPU 55 constituting the second information writing device is provided on the apparatus body side. This allows the unit information Du to be written from the memory section 54 on the apparatus body side to the memory section 64 on the unit side, when power supply to the apparatus body is cut of when a prescribed number of sheets are printed, when the unit replacement operation has started, or when the life span of a part has expired. Moreover, even when writing of information from the memory section 54 on the apparatus body side to the memory section 64 on the unit side has failed, this structure ensures secure management of the life span of the photoreceptor drum 1Y, charging device 2Y, image writing section 3Y, developing device 4Y or cleaning section 8Y for yellow constituting the image forming unit 10Y at the time of the recovery.

The control section 15 is provided with a determination device to be run by software. The determination device uses the RAM 53 and CPU 55 to determine whether or not the unit information Du should be written from the memory section 64 of the unit side to the memory section 54 on the apparatus body side, according to the identification information ID and information on the number of times each part has been used. In this example, when power is supplied or the unit is mounted, the unit information Du can be written from the memory section 64 on the unit side to the memory section 54 on the apparatus body side, in response to the result of determination obtained by the determination function implemented by the RAM 53 and CPU 55 and based on the identification information ID.

Further, the control section 15 has a memory selection device to be run by software. The memory selection device is made up of a RAM 53 and CPU 55. It selects a plurality of body memory areas #A, #B and #C set in the memory section 54 in conformity to the identification information ID of the replaceable image forming unit 10Y. The selection of the body memory areas #A, #B and #C permits the unit information Du to be written from the memory section 64 on the unit side to the memory area selected in the memory section 54 on the apparatus body side when power is supplied or the unit is mounted. Further, the selection of the body memory areas #A, #B and #C allows the unit information Du to be written to the memory section 64 on the unit side from the body memory area #A and others selected in the memory section 54 on the apparatus body side, when power supply to the apparatus body is cut off, when a prescribed number of sheets are printed, when the unit replacement operation has started, or when the life span of a part has expired.

In this example, the unit information Du stored in the memory section 54 includes the unit information Du of the replacement date of the image forming unit 10Y and others. Under this condition, the CPU 55 determines whether or not a plurality of body memory areas #A, #B, #C and others set in the memory section 54 are all used or not. At the same time, the CPU 55 determines whether or not the identification information ID of the image forming unit 10Y and others which is not present in any of the body memory areas #A, #B and #C has been read. The CPU 55 provides memory selection control in such a way as to select the memory area storing the unit information Du of the image forming unit 10Y of the oldest replacement date, based on the result of this determination.

The aforementioned memory selection control ensures that the body memory area storing the unit information Du of the image forming unit 10Y of the oldest replacement date, for example, the area #A is selected, when the identification information ID of a new image forming unit 10Y which is not present in any of the body memory areas #A, #B and #C has been read. This ensures effective use of the limited body memory areas #A, #B and #C in the memory section 54 on the apparatus body side.

The aforementioned control section 15 is connected with the communication section 19. The communication section 19 is connected with the communication section 29 on the unit side. When the unit information Du is written to the memory section 64 on the unit side, the communication section 19 performs communication processing under the control of the CPU 55. For the image forming units 10M, 10C and 10K of magenta, cyan and black colors, the unit information Du is processed in the similar manner.

The control section 15 is connected with the image reading device 102. The image reading device 102 ensures that the color digital image data D12 (component data for each of colors R, G and B) obtained by reading the image from the document 30 of FIG. 1 is outputted to the control section 15. The control section 15 ensures that the image data D12 inputted from the image reading device 102 is color-converted into the yellow image forming image data Dy, magenta image forming image data Dm, cyan image forming image data Dc and black image forming image data Dk. After the processing of color conversion, the yellow, magenta, cyan and black image forming image data Dy, Dm, Dc and Dk are stored in the memory section 54, or yellow image forming device buffer 31 or the magenta, cyan and black image forming device buffers 31 of FIG. 1.

The control section 15 is connected with the sheet conveyance section 20. The sheet conveyance section 20 provides motor speed control based on the sheet conveyance signal S20, and conveys the sheet P fed out of the sheet feed tray 20A, 20B or 20C to the image forming section 60. The sheet conveyance signal S20 is supplied from the control section 15 to the sheet conveyance section 20.

The aforementioned control section 15 is connected with a fixing device 17. The fixing device 17 fixes the color image secondarily transferred onto the sheet Pin response to the fixing control signal S17 outputted from the control section 15. This is the structure of the color copier 100.

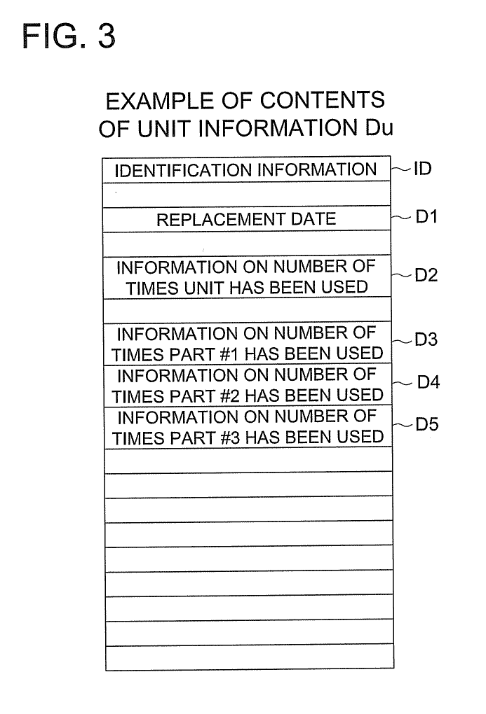

Referring to FIG. 3, the following describes the example of the contents of the unit information Du. The unit information Du of FIG. 3 includes the itemized description of the identification information ID, replacement date information D1, information D2 on the number of times the unit has been used, information D3 on the number of times the part #1 has been used, information D4 on the number of times the part #2 has been used, information D5 on the number of times the part #3 has been used, and other information. The identification information ID denotes the individual identification for identifying the function implementation unit. For example, the identification information includes the manufacturing code (Y0001) for identifying the image forming unit 10Y (regularly installed parts) and the manufacturing codes (Y0002, Y0003) of the image forming unit 10Y constituting the spare parts thereof.

The replacement date information D1 represents the data on the date when the function implementation unit is replaced. For example, it is the data on the date (e.g., Dec. 8, 2009) when the image forming unit 10Y as a regularly installed part was replaced by the image forming unit 10Y as a spare part. The information D2 on the number of times of unit use is the data indicating the number of times the function implementation unit has been used. For example, it is the data on the number of times the image forming unit 10Y as a regularly installed part has been used (1,000 times). The information D3 on the number of times of part #1 use is the data on the number of times the part #1 of the function implementation unit has been used. For example, it is the data on the number of times the photoreceptor drum 1Y of the image forming unit 10Y as a regularly instilled part has been used (1,000 times).

The information D4 on the number of times of part #2 use represents the number of times the part #2 of the function implementation unit has been used. For example, it indicates the data on the number of times the charging device 2Y of the image forming unit 10Y as a regularly installed part has been used (1,000 times). The information D5 on the number of times of part #3 use indicates the data on the number of times the part #3 of the function implementation unit has been used. For example, it indicates the data on the number of times the charging device 3Y of the image forming unit 10Y as a regularly installed part has been used (1,000 times). The unit information Du is made up of the identification information ID, replacement date information D1, information D2 on the number of times of unit use, information D3 on the number of times of part #1 use, information D4 on the number of times of part #2 use, and information D5 on the number of times of part #3 use. The unit information Du is stored in the memory section 54 on the apparatus body side and the memory section 64 on the unit side.

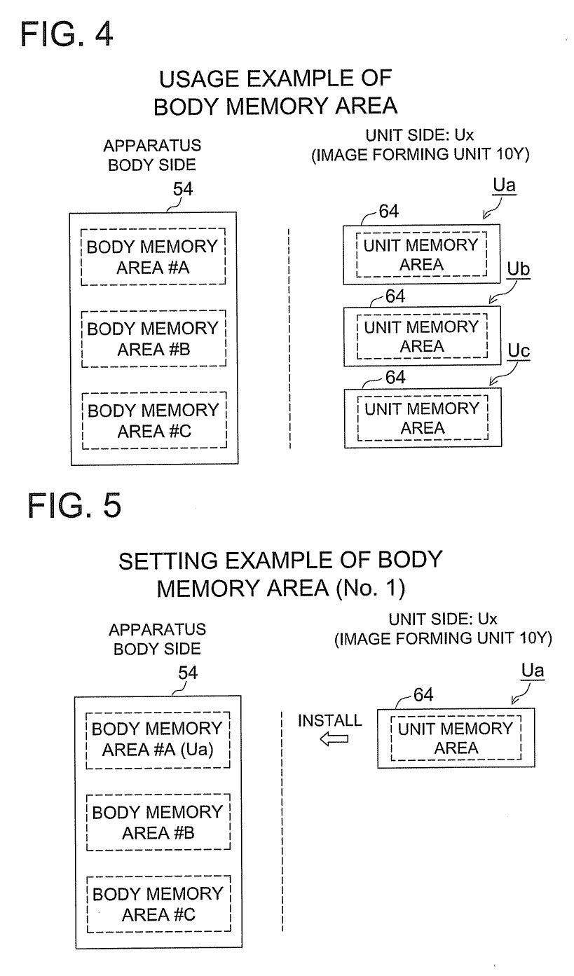

Referring to FIG. 4, the following describes the usage example of the body memory area on the apparatus body side. In FIG. 4, for the apparatus body side, only the memory section 54 is picked up from the control section 15 of FIG. 2. For the unit side, only the memory section 64 is picked up from each control section 125 of the image forming unit 10Y as a regularly installed or spare part.

The memory section 54 has three body memory areas #A, #B and #C for unit managements for a total of three image forming units 10Y, i.e., one regularly installed part and two spare parts. In this example, the image forming unit 10Y as a regularly installed part is originally mounted on the apparatus body side at the time of shipment from the factory. The image forming unit 10Y as a spare part is attached as a spare part at the time of shipment from the factory, or is a unit newly obtained and mounted subsequent to the shipment from the factory.

In this example, the image forming unit 10Y as a regularly installed part is called the unit Ua, and two image forming units 10Y as spare parts are called the units Ub and Uc, respectively. Each of the units Ua through Uc has a unit memory area. In the following description, the unit mounted on the apparatus body side will be called the Ux.

Referring to FIGS. 5 through 11, the following describes examples of setting and updating the body memory area on the apparatus body side. In this embodiment, as shown in FIG. 5, the memory area for unit management on the apparatus body side is divided into three body memory areas #A, #B and #C. Three replaceable units Ux=Ua through Uc (=image forming units 10Y) are used to ensure accurate management of the life span of the photoreceptor drum 1Y, charging device 2Y, image writing section 3Y, developing device 4Y or cleaning section 8Y for yellow constituting each of the image forming units 10Y.

For example, the unit memory area of unit Ux=Ua as a regularly installed part is set at the body memory area #A for unit management of FIG. 5 at the time of shipment from the factory. In this case, the initial states of the body memory areas #A through #C for unit management are unused state. It should be noted, however, that the number of dividing memory area for unit management is not restricted to three.

In this example, when the unit Ux=Ua is mounted on the apparatus body side and power is turned on, the control section 15 of FIG. 2 inputs from the unit Ux=Ua the identification information ID and the information on the number of times each part has been used. Comparative reference is made between the identification information ID and information on the number of times each part has been used, and their respective comparative reference information items. Then a step is taken to determine whether or not the unit information Du should be written to the memory section 54 on the apparatus body side from the memory section 64 of unit Ux=Ua. If it has been determined that the identification information ID agrees with the comparative reference information for ID determination, and the information on the number of times each part has been used satisfies the comparative reference information for evaluating the number of times, the unit memory area of the unit Ux=Ua is set corresponding to the body memory area #A of the memory section 54.

This setting allows the unit Ux=Ua to process information using the body memory area #A. For example, the unit information Du written to the unit memory area of unit Ux=Ua is sent to the body memory area #A on the apparatus body side and is stored there. The body memory areas #B and #C are both unused at this moment.

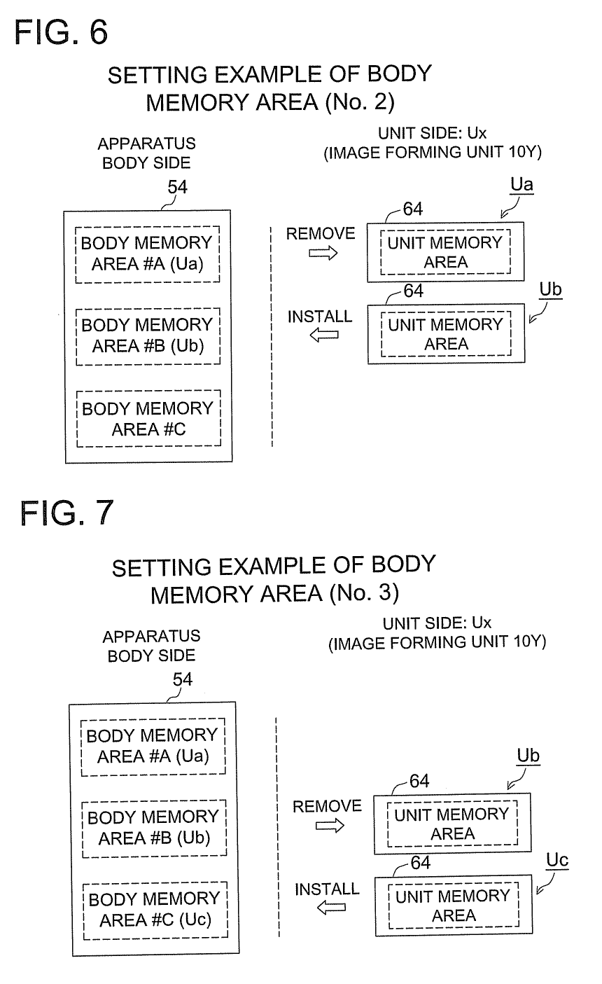

In the embodiment of FIG. 6, for example, the unit Ux=Ua is removed from the apparatus body side, and the unit Ux=Ub as a spare part is mounted, and the unit memory area of the unit Ux=Ub is set in the body memory area #B. In this case, the body memory area #A for unit management is already set for the unit Ux=Ua. The body memory areas #B and #C are both unused.

In this example, the unit Ux=Ua is removed from the apparatus body side and the unit Ux=Ub is mounted on the apparatus body. When power is turned on, the control section 15 of FIG. 2 inputs from the unit Ux=Ub the identification information ID and information on the number of times each part has been used. Comparative reference is mane between the identification information ID and the information on the number of times of use, and their respective comparative reference information items. Then a step is taken to determine whether or not the unit information Du should be written from the memory section 64 of unit Ux=Ub to the memory section 54 on the apparatus body side. If it has been determined that there is agreement of the identification information ID as described above, and the information on the number of times of use meets the requirements of the aforementioned comparative reference information, the unit memory area of the unit Ux=Ub is set corresponding to the body memory area #B of the memory section 54.

This setting allows the information to be processed by the unit Ux=Ub using the body memory area #B. For example, the unit information Du written in the unit memory area of the unit Ux=Ub is transferred to the body memory area #B on the apparatus body side, and this unit information Du is stored. Another body memory area #C is unused at present.

Further, the embodiment of FIG. 7 shows the case where the unit Ux=Ub is removed from the apparatus body side and the unit Ux=Uc as a spare part is mounted, and the unit memory area of the unit Ux=Uc is set in the body memory area #C. In this case, the body memory areas #A and #B for unit management have already been set for the unit Ux=Ua, Ub. Another body memory area #C is unused.

In this example, the unit Ux=Ub is removed from the apparatus body side and the unit Ux=Uc is mounted on the apparatus body side. When power is turned on, the control section 15 of FIG. 2 provides control in such a way that the identification information ID and information on the number of times each part has been used are inputted from the unit Ux=Uc. Comparative reference is made between the identification information ID and the information on the number of times of use, and their respective comparative reference information items. Then a step is taken to determine whether or not the unit information Du should be written from the memory section 64 of the unit Ux=Uc to the memory section 54 on the apparatus body side. Wit has been determined that there is agreement of the identification information ID, and the information on the number of times of use meets the requirements of the aforementioned comparative reference information, the unit memory area of the unit Ux=Uc is set corresponding to the body memory area #C of the memory section 54.

This setting allows the information to be processed by the unit Ux=Uc using the body memory area #C. For example, the unit information Du written in the unit memory area of the unit Ux=Uc is transferred to the body memory area #C on the apparatus body side, and this unit information Du is stored. All the body memory areas #A through #C have already been set in this case.

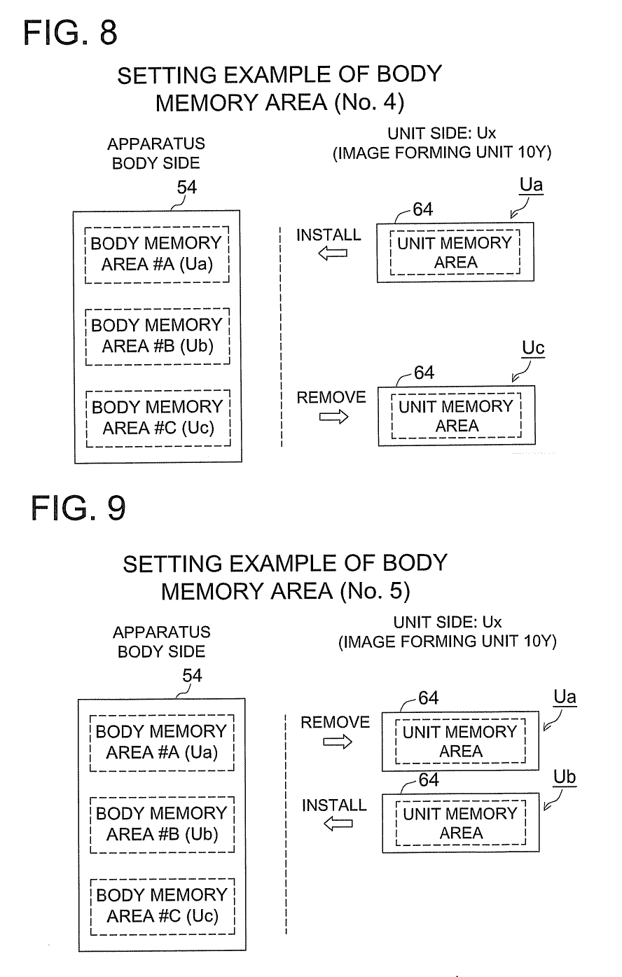

Further, the embodiment of FIG. 8 shows the case where the unit Ux=Uc is removed from the apparatus body side and the unit Ux=Ua as a regularly installed part is mounted, and the unit memory area of the unit Ux=Ua is updated in the body memory area #A. In this case, the body memory areas #A through #C for unit management have already been set for the unit Ux=Ua, Ub, Uc.

In this example, the unit Ux=Uc is removed from the apparatus body side and the unit Ux =Ua is mounted on the apparatus body side. When power is turned on, the control section 15 of FIG. 2 provides control in such a way that the identification information ID and information on the number of times each part has been used are inputted from the unit Ux=Ua. Comparative reference is made between the identification information ID and the information on the number of times of use, and their respective comparative reference information items. Then a step is taken to determine whether or not the unit information Du should be written from the memory section 64 of the unit Ux=Ua to the memory section 54 on the apparatus body side. The information on the number of times of use includes the information on the number of times of use of such a part as the photoreceptor drum 1Y, charging device 2Y, image writing section 3Y, developing device 4Y or cleaning section 8Y for yellow constituting the image forming unit 10Y.

The control section 15 makes comparison between the information on the number of times each part has been used, and the comparative reference information for determination of the number of times of use, and determines whether or not the number of times Nx each part has been used has exceeded the number of times in comparative reference. If the number of times Nx each part has been used does not exceed the number of times in comparative reference, a step is taken to update the permission of writing from the unit memory area of the unit Ux=Ua to the body memory area #A of the memory section 54.

This updating procedure enables the unit Ux=Ua to use the body memory area #A on a continuous basis and to process information. For example, the unit information Du written into the unit memory area of the unit Ux=Ua is transferred to the body memory area #A on the apparatus body side, and the unit information Du is stored as update. This arrangement allows the use of the body memory area #A by the unit Ux=Ua to be updated according to the information on the number of times each part has been used.

If the number of times Nx each part has been used has exceeded the number of times in comparative reference, the request of writing from the unit memory area of the unit Ux=Ua to the body memory area #A of the memory section 54 is rejected. This rejection of the request for updating disables continued use of the body memory area #A. Since the life span of this unit Ux=Ua has expired, a message of “Please replace the unit Ux=Ua since the life span has expired” is displayed on the operation display section 48 or the like in the form of character information.

Further, the embodiment of FIG. 9 shows the case where the unit Ux=Ua is removed from the apparatus body side, the unit Ux=Ub as a spare part is mounted, and the unit memory area of the unit Ux=Ub is updated in the body memory area #B. In this case, the body memory areas #A through #C for unit management have already been set for the unit Ux=Ua, Ub, Uc.

In this example, the unit Ux=Ua is removed from the apparatus body side and the unit Ux=Ub is mounted on the apparatus body side. When power is turned on, the control section 15 of FIG. 2 provides control in such a way that the identification information ID and information on the number of times of use are inputted from the unit Ux=Ub. Comparative reference is made between the identification information ID and information on the number of times of use, and their respective comparative reference information items. Then a step is taken to determine whether or not the unit information Du should be written from the memory section 64 of the unit Ux=Ub to the memory section 54 on the apparatus body side.

In this example as well, the control section 15 compares between the number of times of the use of such a part as the photoreceptor drum 1Y, charging device 2Y, image writing section 3Y, developing device 4Y or cleaning section 8Y for yellow constituting the image forming unit 10Y, and the comparative reference information on the number of times of the use of each part. The control section 15 determines whether or not the number of times Nx each part has been used has exceeded the number of times in comparative reference. If the number of times Nx each part has been used does not exceed the number of times in comparative reference, the control section 15 updates the permission to write from the unit memory area of the unit Ux=Ub to the body memory area #B of the memory section 54.

This updating enables the unit Ux=Ub to use the body memory area #B on a continuous basis and permits information to be processed. For example, the unit information Du written in the unit memory area of the unit Ux=Ub is transferred to the body memory area #B on the apparatus body side, and the unit information Du is updated and stored. This procedure enables the body memory area #B of the unit Ux=Ub to be updated in conformity to the information on the number of times each part has been used.

If the number of times Nx each part has been used has exceeded the number of times in comparative reference, a request for writing from the unit memory area of the unit Ux=Ub to the body memory area #B of the memory section 54 is rejected. This rejection of updating disables the unit Ux=Ub to use the body memory area #B on a continuous basis. Since the life span of this unit Ux=Ub has expired, a message of “Please replace the unit Ux=Ub since the life span has expired” is displayed on the operation display section 48 and others in the form of character information.

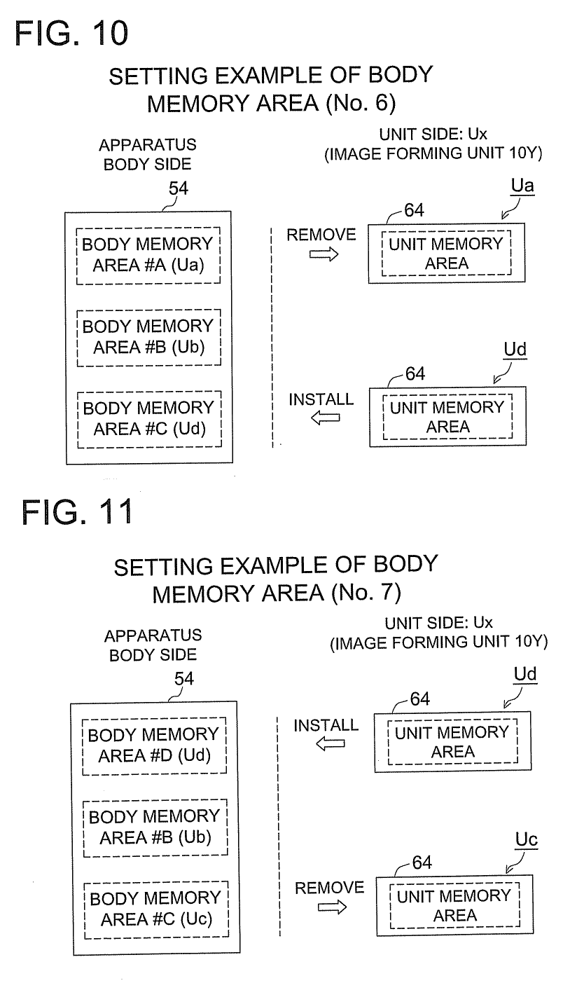

The embodiment of FIG. 10 shows the case where the unit Ux=Ua is removed from the apparatus body side, and the unit Ux=Ud having new information is mounted. Further, the unit memory area of the unit Ux=Ud is set by changing the body memory area #C to #D. In this case, the body memory areas #A and #B for unit management have already been set for the unit Ux=Ua, Ub. The body memory area #C is unused.

Under this condition, the unit Ux=Ua is removed from the apparatus body side and the unit Ux=Ud is mounted on the apparatus body side. When power is turned on, the control section 15 of FIG. 2 provides control in such a way that the identification information ID and information on the number of times of use are inputted from the unit Ux=Ud. Comparative reference is made between the identification information ID and information on the number of times of use, and their respective comparative reference information items. Then a step is taken to determine whether or not the unit information Du should be written from the memory section 64 of the unit Ux=Ud to the memory section 54 on the apparatus body side. This is the aforementioned case where the identification information ID does not agree with any of the items of identification information ID of the unit Ux=Ua through Uc.

In this case, the control section 15 determines whether or not a plurality of body memory areas #A, #B and #C set on the memory section 54 have all been used. The control section 15 also determines whether or not the identification information ID of the image forming unit 10Y and others which is not present in any of the body memory areas #A, #B and #C has been read. Based on the result of this determination, the control section 15 controls the memory selection so as to select any one of the body memory areas #A, #B and #C.

An example is found in the case where, instead of the unit Ux=Uc which is expected to be set in the body memory area #C, the unit Ux=Ud has been mounted. In this case, the body memory area #C where writing by the unit memory area of the unit Ux=Uc has been allowed is changed to the body memory area #D.

Thus, even when the identification information ID of a new image forming unit 10Y which is not present in any of the body memory areas #A, #B and #C has been read, this memory selection control selects the body memory area #C which is expected to be set for the unit Ux=Uc and changes it to the body memory area #D. This provides an effective use of the limited body memory areas #A, #B and #C in the memory section 54 on the apparatus body side.

The embodiment of FIG. 11 shows the case where the unit Ux=Ua is removed from the apparatus body side, the emit Ux=Ud containing new identification information ID is mounted, and the unit memory area of the unit Ux=Ud is set in the body memory area #A, #B or #C. The unit Ux=Ud contains the identification information ID which is not set (registered) in the apparatus body. In this case, the body memory areas #A through #C for unit management have already been set for the unit Ux=Ua, Ub, Uc. The unit information Du stored in the memory section 54 contains the unit information Du of the replacement date of the image forming unit 10Y and others.

Under this condition, the unit Ux=Ua is removed from the apparatus body side, and the unit Ux=Ud is mounted on the apparatus body side. When power is turned on, the control section 15 of FIG. 2 provides control in such a way that the identification information ID and information on the number of times in use are inputted from the unit Ux=Ud. Comparative reference is made between the identification information ID and information on the number of times in use, and their respective comparative reference information items. Then a step is taken to determine whether or not the unit information Du should be written from the memory section 64 of the unit Ux=Ud to the memory section 54 on the apparatus body side. This is the aforementioned case where the identification information ID does not agree with any of the items of identification information ID of the unit Ux=Ua through Uc.

In this case, the control section 15 determines whether or not a plurality of body memory areas #A, #B and #C set on the memory section 54 have all be used. The control section 15 also determines whether or not the identification information ID of the image forming unit 10Y and others which is not present in any of the body memory areas #A, #B and #C has been read. Based on the result of this decision, the control section 15 controls the memory selection so as to select any one of the body memory areas #A, #B and #C storing the unit information Du of the oldest replacement date of the image forming unit 10Y.

An example is found in the case where the unit Ux=Ua set in the body memory area #A stores the unit information Du of the image foaming unit 10Y in the oldest replacement date, as compared to the other units Ux=Ub, Uc. In this case, a step is taken to select the body memory area #A where writing by the unit memory area of the unit Ux=Ua is allowed. The body memory areas #B and #C remain unchanged.

This memory selection control ensures that, when new identification information ID of the image forming unit 10Y not present in any of the body memory areas #A, #B and #C has been read, a step is taken to select the body memory area #A storing the unit information Du of the oldest replacement date of the image forming unit 10Y. Then the unit Ux=Ud is allowed to process information using the body memory area #D having been changed from the body memory area #A. This ensures an effective use of the limited body memory areas #A, #B and #C in the memory section 54 on the apparatus body side.

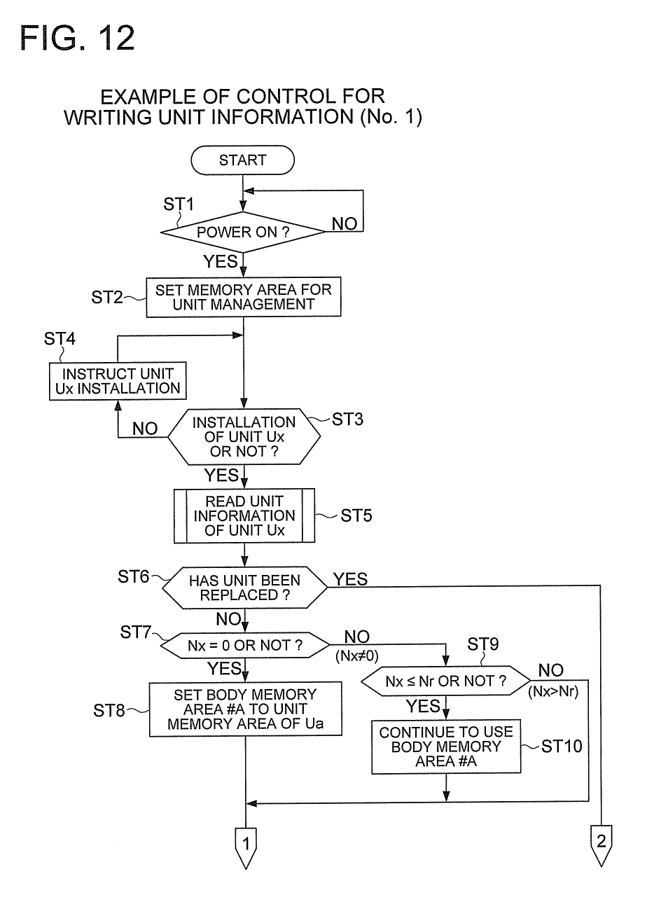

Referring to FIGS. 12 through 14, the following describes a control method of the image forming apparatus related to the present invention, with reference to control example of the color copier 100. This embodiment assumes the case where three body memory areas #A, #B and #C for unit management are set in the memory section 54 of the control section 15 by the color copier 100 that can be used by replacing the image forming unit 10Y and others mounted on the photocopier body 101 to share the load of implementing the image forming output function. This embodiment is also based on the assumption that the three body memory areas #A, #B and #C having been set are used to control the three yellow image forming units 10Y (hereinafter referred to as “unit Ux=Ua, Ub, Uc”) that can be replaced on the photocopier body 101, and the unit information Du is written for each of the unit Ux=Ua through Uc.

In this example, the unit mounted on the apparatus body side is assumed as the Ux. It is further assumed that the unit Ux=Ua is a regularly installed part, and the units Ux=Ub, Uc are spare parts. Also assume that, in the initial state at the time of shipment from the factory, unit Ux=Ua is mounted on the apparatus body side. It should be noted that an example is also taken from the case of control where the unit Ux=Ud of new identification information ID is mounted, as an exception of the aforementioned three units Ux=Ua, Ub, Uc.

Under the aforementioned control conditions, the CPU 55 of FIG. 2 in Step ST1 of FIG. 12 waits for the power to be turned on. Normally, the clock function of the minimum requirement is operating in the color copier 100. Other functions are placed in the sleep mode. For example, when power is supplied, the power ON information is detected by the CPU 55.

When power is supplied, the CPU 55 sets three body memory areas #A, #B and #C for unit management in the memory section 54 in Step ST2. In this example, the body memory area #A is assigned to the unit Ux=Ua, the body memory area #B is assigned to the unit Ux=Ub, and the body memory area #C is assigned to the unit Ux=Uc.

In Step ST3, control branches off depending on whether or not the unit Ux is amounted on the apparatus body side. If the unit Ux is not mounted on the apparatus body side, in Step ST4, the CPU 55 controls the operation display section 48 to mount the unit Ux on the apparatus body side. The operation display section 48 inputs the display data D18 from the control section 15, and displays the message “Please mount the unit Ux on the apparatus body side” in the form of character information according to the display data D18. This message is intended to ensure that the unit is mounted on the apparatus body side.

When the unit Ux is mounted on the apparatus body side, the CPU 55 reads the unit information Du from the unit Ux in Step ST5. In this case, the CPU 65 of the unit Ux reads the unit information Du from the memory section 64, and transfers the unit information Du to the control section 15 through the communication section 29 and communication section 19 on the apparatus body side. The unit information Du read from the unit Ux includes the identification information ID and the information on the number of times each part has been used. When the unit Ux is the unit Ua, the identification information ID indicates this unit Ua. If the unit Ua is placed in the initial state at the time of shipment from the factory, the number of times Nx each part has been used is zero.

In Step ST6, the CPU 55 branches off the control depending on the presence or absence of the instruction to replace the unit Ux. In this example, the CPU 55 determines whether or not the identification information ID of the unit Ux mounted on the apparatus body side is different from the identification information ID of the unit Ua in the initial state which is already allowed to be written to the body memory area #A. For example, the CPU 55 compares between the identification information ID read from the unit Ux and the comparative reference information for ID judgment, and determines whether the identification information ID agrees with the comparative reference information for ID judgment (Ux=Ua) or not (Ux Ua).

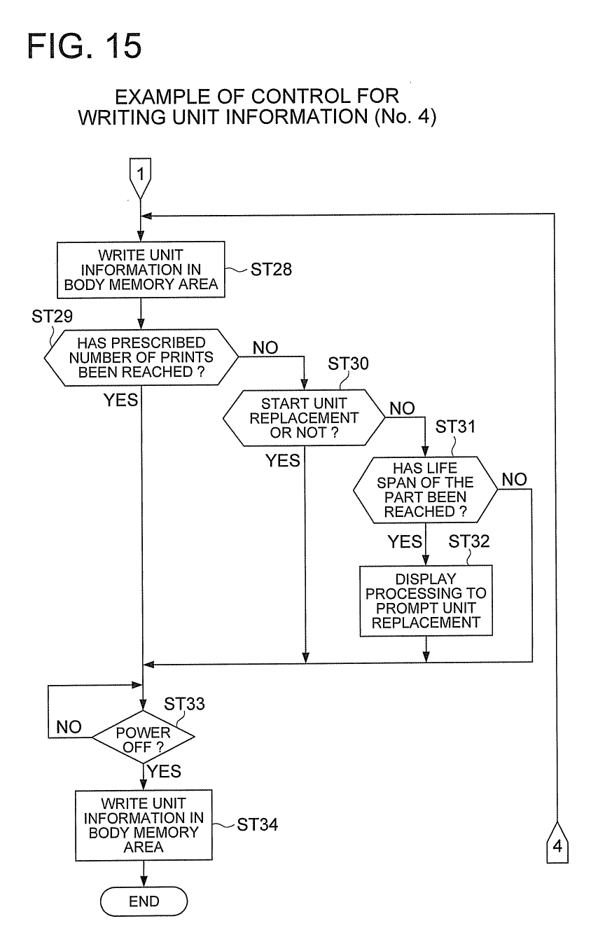

In this example, unit Ux=Ua in the initial state. Thus, the CPU 55 determines that it is unit Ux=Ua, and there is no replacement of the unit. If it has been determined that there is no instruction to replace the unit Ux, the CPU 55 obtains in Step ST7 from the unit information Du the information on the number of times each part has been used, and branches the control depending on whether or not the body memory area #A has been used. In this case, the CPU 55 determines whether Nx=0 or Nx≠0, assuming that the number of times each part has been used, written in the body memory area #A, is Nx. The number of times Nx of use of each part is obtained from the information on the number of times each part has been used. If Nx=0 has been determined, the operation proceeds to Step ST8, and the CPU 55 sets the body memory area #A to the unit memory area of the unit Ux=Ua. In this example, the number of times Nx each part of the unit Ua in the initial state has been used at the time of shipment from the factory is “0”. Thus, the unused body memory area #A is set to the unit memory area of the unit Ux=Ua. This setting allows the unit Ua to use the body memory area #A to process information (FIG. 5). After that, the operation goes to the Step ST28 of FIG. 15.

With respect to the number of times Nx each part has been used, if Nx≠0 has been determined, the operation goes to Step ST9, and the information on the number of times of use and comparative reference information are inputted. The CPU 55 branches the control depending on whether Nx≦Nr or not. In this case, Nr is a comparative reference value for determining the number of times of use of each part. The comparative reference value Nr can be obtained from the comparative reference information. When the number of times Nx each part has been used is equal to or below the comparative reference value Nr of the part (hereinafter referred to as “Nx≦Nr”), the CPU 55 continues to use the body memory area #A in Step ST10, for the unit memory area of the unit Ux=Ua. If the number of times Nx each part has been used exceeds the comparative reference value Nr of the part (hereinafter referred to as “Nx>Nr”), the operation proceeds to Step ST28.

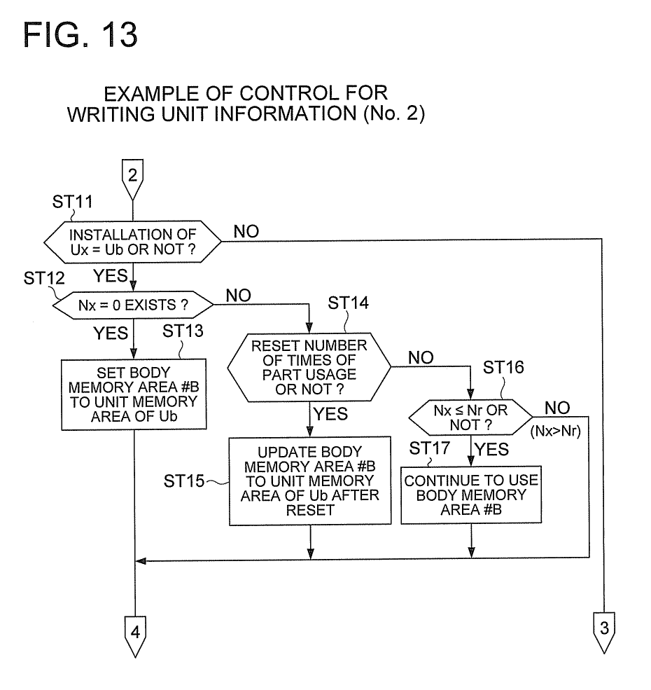

If the unit Ub, instead of the unit Ua, has been mounted for maintenance or other purposes, in the aforementioned Step ST6, the CPU 55 considers that the unit Ux has been changed from the unit Ua to other units Ub, Uc or a new unit Ud. In this example, if the unit Ux mounted on the apparatus body side is not the unit Ua, but units Ub, Uc or another unit Ud, the identification information ID of the unit Ub, Uc or another unit Ud is different from the identification information ID of the unit Ua where writing in the body memory area #A has been already allowed. Thus, the CPU 55 determines that there is replacement of the unit. This decision allows the operation to go to the Step ST11 of FIG. 13. The CPU 55 branches the control, depending on whether unit Ux=Ub has been mounted or the unit Uc or another, other than unit Ux=Ub has been mounted. For example, the CPU 55 branches the control, depending on whether the identification information ID of the unit Ux agrees with the identification information ID of the unit Ub which is allowed to be written to the body memory area #B.

If the unit Ux=Ub has been mounted, i.e., if the identification information ID of the unit Ux agrees with the identification information ID of the unit Ub which is allowed to be written to the body memory area #B, the CPU 55 branches the control in Step ST12, depending on whether or not there is any unused body memory area #B other than the body memory area #A. With respect to the number of times Nx each part has been used, if there is a body memory area #B or #C wherein Nx=0, the operation proceeds to Step ST13. The CPU 55 sets the body memory area #B to the unit memory area of the unit Ux=Ub. This setting allows the unit Ub to use the body memory area #B to process information (FIG. 6). After that, the operation proceeds to Step ST28.

With respect to the number of times Nx of use of the part, if Nx≠0, the CPU 55 branches the control in Step ST14 depending on whether or not the number of times Nx in use of the part of the unit Ub has been reset. If the number of times Nx in use of the part of the unit Ub has been reset, in Step ST15, the CPU 55 updates the body memory area #B to the unit memory area of the unit Ub subsequent to resetting. After that, the operation proceeds to Step ST28.

If the number of times Nx the part of the unit Ub has been used is not reset in the aforementioned Step ST14, control is branched off in Step ST15, depending on whether Nx≦Nr or not, with respect to the number of times Nx each part has been used. With respect to the number of times Nx each part has been used, if Nx≦Nr, the CPU 55 continues use of the body memory area #B as the unit memory area of the unit Ux=Ub in Step ST17. If Nx>Nr, the operation proceeds to Step ST28.

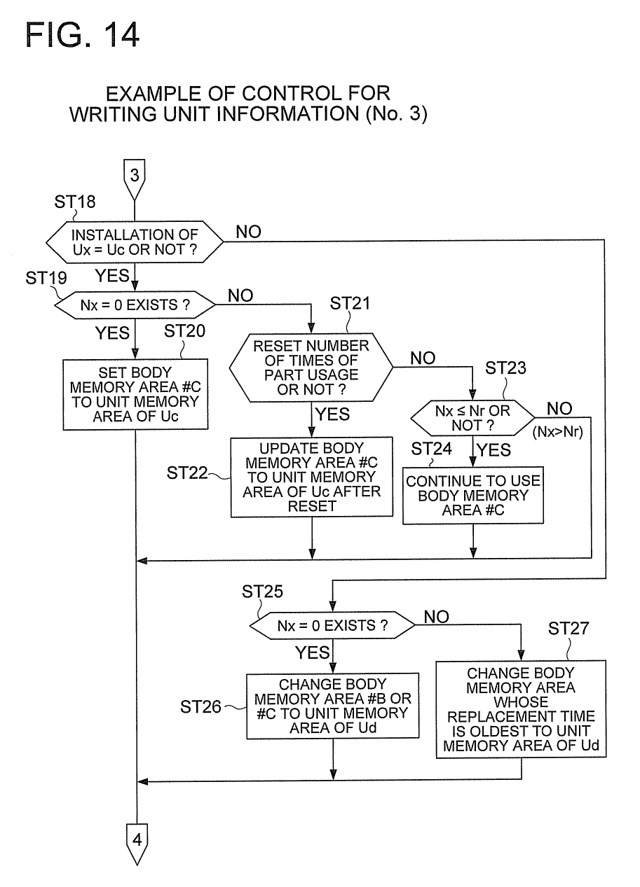

If a unit Uc or the like other than unit Ux=Ub is mounted on the apparatus body side in Step ST11, the operation proceeds to Step ST18 of FIG. 14. The CPU 55 branches the control, depending on the unit Ux=Uc has been mounted, or a unit Ud or the like other than unit Ux=Uc has been mounted. For example, a step is taken to determine whether or not the identification information ID agrees with the identification information ID which is allowed to be written into the body memory area #B or #C.

If the unit Ux=Uc has been mounted, i.e., if the identification information ID of the unit Ux agrees with the identification information ID of the unit Uc which has been already allowed to be written to the body memory area #C, the CPU 55 branches the control in Step ST19, depending on whether body memory area #C has been used or not. Assuming that the number of times of use of each part to be written to the body memory area #C is Nx, the CPU 55 determines whether Nx=0 or Nx≠0. If Nx=0 has been determined, the operation proceeds to Step ST20. The CPU 55 sets the body memory area #C to the unit memory area of unit Ux=Uc. This setting allows the unit Uc to use the body memory area #C to process information (FIG. 7). After that, the operation proceeds to Step ST28.

If Nx=0 with respect to the number of times Nx each part has been used, the operation proceeds to Step ST20, and the CPU 55 sets the body memory area #C to the unit memory area of the unit Ux=Uc. After that, the operation proceeds to Step ST28 of FIG. 15. If Nx≠0 with respect to the number of times Nx each part has been used, the CPU 55 branches the control in Step ST21, depending on whether the number of times Nx in use of each part of the unit Uc has been reset or not. If the number of times Nx in use of each part of the unit Uc has been reset, the CPU 55 updates the body memory area #C, in Step ST22, as the unit memory area of the unit Uc after the reset. After that, the operation proceeds to Step ST28 of FIG. 15.

If the number of times Nx in use of each part of the unit Uc has not been reset in the aforementioned Step ST21, the CPU 55 branches the control in Step ST23, depending on whether Nx≦Nr or not for the number of times Nx each part has been used. If Nx≦Nr for the number of times Nx each part has been used, the CPU 55 continues to use the body memory area #C as the unit memory area of the unit Ux=Uc in Step ST24. If Nx>Nr, the operation proceeds to Step ST28.

If the unit Ud other than the unit Ux=Ua, Ub, Uc is mounted in Step ST18, i.e., if the identification information ID of the unit Ux fails to agree with any of the identification information ID of the unit Ub allowed to be written to the body memory area #B, and identification information ID of the unit Uc allowed to be written to the body memory area #C, then the operation proceeds to Step ST25. The CPU 55 branches the control, depending on whether an unused body memory area #A, #B or #C is present or not.

If a unused (Nx=0) body memory area #B or #C is present for the number of times Nx each part has been used, the operation proceeds to Step ST26, the CPU 55 changes any one of the body memory areas #B and #C to the unit memory area of the unit Ud. If an unused (Nx=0) body memory area #B or #C is not present for the number of times Nx each part has been used, the operation proceeds to Step ST27. The CPU 55 changes the body memory area #A, #B or #C of the oldest replacement time to the unit memory area of the unit Ud.

In Step ST28 of FIG. 15, the CPU 55 writes the unit information Du to the body memory area #A, #B or #C. This unit information Du contains the identification information ID of the unit Ux and the number of times Nx each part has been used. For example, if unit Ux=Ua is mounted on the apparatus body side, the unit information Du written in the unit memory area of the unit Ua is transferred to the body memory area #A, and the unit information Du is stored.

When unit Ux=Ub is mounted on the apparatus body side, the unit information Du written in the unit memory area of the unit Ub is transferred to the body memory area #B, and the unit information Du is stored. When unit Ux=Uc is mounted on the apparatus body side, the unit information Du written in the unit memory area of the unit Uc is transferred to the body memory area #C, and the unit information Du is stored. In the case of a new unit Ud, the unit information Du is transferred to the body memory area #B or #C, or the body memory area #D changed from the body memory area #A, and the unit information Du is stored.

In Step ST29, the CPU 55 branches the control depending on whether the number of prints has reached a prescribed number of sheets or not. If the number of prints has reached a prescribed number of sheets, the operation proceeds to Step ST33. If the number of prints has not yet reached a prescribed number of sheets, the operation proceeds to Step ST30. The CPU 55 branches the control depending on whether the unit replacement has started or not. If the unit replacement has started, the operation proceeds to Step ST33. If the unit replacement has not yet started, the operation proceeds to Step ST31. The CPU 55 branches the control depending on whether the life span of the part has expired or not. If the life span of the part has not yet expired, the operation proceeds to Step ST33. If the life span of the part has expired, the operation proceeds to Step ST32. The CPU 55 controls the display of the operation display section 48 to prompt the user to replace the unit. For example, the operation display section 48 displays the message “The life span of the unit has expired. Replacement of the unit is recommended.” in the form of character information.

In Step ST33, the CPU 55 detects power off information. When power off information has been detected, the operation proceeds to Step ST34. The CPU 55 writes the description of the unit memory area in the body memory area For example, the CPU 65 of the unit Ua reads the unit information Du from the memory section 64 and transfers the unit information Du to the CPU 55 of the control section 15 through the communication section 29 and communication section 19 on the apparatus body side. The CPU 55 reads the unit information Du from the unit Ua, and writes it to the body memory area #A on the apparatus body side.

Alternatively, the CPU 55 reads unit information Du transferred from unit Ub, and write it to the body memory area #B on the apparatus body side in the similar manner. Alternatively, the CPU 55 reads unit information Du transferred from unit Uc, and write it to the body memory area #C on the apparatus body side in the similar manner. Alternatively, the CPU 55 reads unit information Du transferred from unit Ud, and write it to the body memory area #D changed from the body memory area #A, #B or #C on the apparatus body side in the similar manner. This terminates information processing related to unit management.

As described above, in the color copier 100 of the present embodiment, the operation display section 48 is operated and three body memory areas #A, #B and #C for unit management are set on the memory section 54. The body memory areas #A, #B and #C store unit information Du for each of the three image forming units 10Y. Under this condition, the CPU 55 of the control section 15 uses the three body memory areas #A, #B and #C of the memory section 54 set by the operation display section 48 to control other image forming units 10Y working as the two spare parts replaceable for image forming unit 10Y or the like, working as the regularly installed parts. Thus, the unit information Du is processed for each image forming unit 10Y.

The aforementioned control and processing ensure smooth and secure management of three body memory areas #A, #B and #C for unit management provided on the memory section 54 and the two or more other image forming units 10Y replaceable for yellow image forming unit 10Y or the like. The same control procedure also ensures smooth and secure unit management for other image forming units 10M, 10C and 10K for M, C and BK colors.

This allows the user to replace and use image forming units for various colors, for example, three image forming units 10Y (unit Ua, Ub, Uc, etc.) appropriately for yellow. For example, this allows the user to replace and use other two image forming units 10Y (Ub, Uc) appropriately for the yellow image forming unit 10Y (unit Ua) and others, in conformity to the information on the number of times each part of the image forming unit 10Y has been used. This arrangement ensures a reduction in the downtime of the photocopier body 101 at the time of replacing the parts constituting the image forming unit 10Y. For the other image forming units 10M, 10C and 10K of M, C and BK colors as well, this arrangement reduces the downtime of the photocopier body 101 at the time of replacement.

Moreover, this arrangement ensures smooth and secure replacement of the old image forming unit 10Y by a new image forming unit 10Y while the limited memory area of the memory section 54 is used. Further, if momentary interruption of power or other reasons have caused a failure in the writing to the body memory areas #A, #B and #C for management of such units as the image forming unit 10Y and others, this arrangement ensures secure management of the life spans of such parts as photoreceptor drum 1Y, charging device 2Y, image writing section 3Y, developing device 4Y and cleaning section 8Y for yellow constituting the image forming unit 10Y and others, when power supply is restored. Accordingly, this provides secure management of the replacement by a new image forming unit 10Y in the limited body memory areas #A, #B and #C in the memory section 54 of the photocopier body 101.

The above description of the embodiment refers to the case where the control is branched depending on whether Nx≦Nr or not for the number of times Nx each part has been used. Without the present invention being restricted thereto, for example, when the unit information Du is written to the image forming unit 10Y and others, the number of times Nx (count) each part has been used, written in the memory section 54 of the photocopier body 101 can be compared with the number of times Nx (count) each part has been used, as written in the memory section 64 of the unit Ux. Then writing of the unit information Du can be controlled, based on the result of this comparison.

For example, it is also possible to arrange such a configuration that comparison is made of the unit information Du to find out the difference in the number of times Nx each part has been used. This is followed by the step of determining whether the difference exceeds the reference value or not. If this difference exceeds the reference value, writing of the unit information Du is rejected. This control arrangement also ensures that the image forming unit 10Y (units Ub and Uc) constituting the two or more replaceable spare parts for the yellow image forming unit 10Y (unit Ua) constituting the regularly installed parts is not used in excess of the indigenous life span.

The embodiments of present invention is preferably used in a color copier, multi-functional peripheral, printer and others which are provided with the replaceable function implementation units that are mounted on the apparatus body to implement the image forming output function.

Based on the Structures described in the Summary, the effects of embodiments will be described as follows.

According to the image forming apparatus of Structure 1 and the control method for the image forming apparatus of Structure 9, the apparatus is provided with a control section for controlling the writing of information for each function implementation unit, using a plurality of memory areas for unit management of the storage section having been set.

This Structure ensures smooth and secure management of a plurality of memory areas for unit management set on the storage section, and two or more replaceable function implementation units for one image forming function. Thus, two or more function implementation units can be replaced and used as appropriate, for one function implementation unit, in conformity to the information on the number of times of use. This reduces the downtime of the apparatus body at the time of replacing the parts constituting the function implementation unit. Moreover, this permits smooth and secure replacement of the old function implementation unit by a new function implementation unit, using the limited memory area in the storage section.

According to the image forming apparatus of Structure 2, the first information writing device is provided on the unit side, and the apparatus body side is provided with a second information writing device. When power is supplied or the unit is mounted, this arrangement permits information to be written from the storage section on the unit side to the storage section on the apparatus body side. Further, this arrangement allows information to be written from the storage section on the apparatus body side to the storage section on the unit side, at the time of power interruption on the apparatus body side, at the time of a prescribed total number of sheets having been printed, at the start of unit replacement operation, or at the time of the life span of parts having expired.

According to the image forming apparatus of Structure 3, when power is supplied to the apparatus body side or when the unit is mounted, the first information writing device on the unit side writes information to the storage section on the apparatus body side. Thus, the information on the number of times the part has been used can be identified on the apparatus body side for each of the parts when power is supplied or the unit is mounted.

According to the image forming apparatus of Structure 4, a control section for controlling the first information writing device is provided on the unit side. If the information on the number of times of use has been reset, this control section provides control in such a way that the information on the number of times the part has been used for each part is written to the storage section on the apparatus body side. Even if writing of information by the first information writing device is disabled, the information on the number of times the part has been used for each part can be written to the storage section on the apparatus body side.

According to the image forming apparatus of Structure 5, the arrangement of this apparatus allows information to be written to the storage section on the unit side by the second information writing device on the apparatus body side at the time of power interruption on the apparatus body side, at the time of a prescribed total number of sheets having been printed, at the start of unit replacement operation, or at the time of the life span of parts having expired. Thus, the information on the number of times the part has been used for each part at the time of power interruption, at the time of a prescribed total number of sheets having been, at the start of unit replacement operation, or at the time of the life span of parts having expired can be identified on the unit side. Even if a failure has occurred in writing information from the storage section on the apparatus body side to the storage section on the unit side, this arrangement ensures secure management of the life span of the parts constituting the function implementation unit when the failure is corrected.

According to the image forming apparatus of Structure 6, the control section is provided with a determination device. This allows information to be written from the storage section on the unit side to the storage section on the apparatus body side in conformance to the result of decision made by the determination device and based on the identification information, when power is supplied or the unit is mounted.

According to the image forming apparatus of Structure 7, the control section is provided with a memory selection device. Thus, when power is supplied or the unit is mounted, information can be written from the storage section on the unit side to the memory area selected in the storage section on the apparatus body side. Further, information can be written to the storage section on the unit side from the memory area selected in the storage section on the apparatus body side at the time of power interruption to the apparatus body, at the time of a prescribed total number of sheets having been printed, at the start of unit replacement operation, or at the time of the life span of parts having expired.

According to the image forming apparatus of Structure 8, a control section is provided to determine whether or not a plurality of memory areas for unit management on the apparatus body side have been all used or not. When the identification information of the function implementation unit not present in any of the memory areas has been read, this control section provides control in such a way as to select the memory area having stored the information of the oldest replacement date of the function implementation unit This arrangement ensures an effective use of the limited memory area of the storage section on the apparatus body side.

What is claimed is:

1. An image forming apparatus comprising:
a replaceable function implementation unit for sharing a load of an image forming output function by being mounted on an apparatus body of the image forming apparatus;
a storage section of an apparatus body side provided with a memory area, for storing information of the function implementation unit;
a setting section for setting a plurality of memory areas for management of the function implementation unit in the memory area of the storage section; and
a control section for controlling writing of information for each function implementation unit, using the plurality of memory areas in the storage section having been set by the setting section.

2. The image forming apparatus of claim 1,
wherein the function implementation unit comprises:
a storage section of a unit side for storing identification information for identifying the function implementation unit, and information on a number of times of use, including a number of times a part constituting the function implementation unit has been used; and
a first information writing device for writing information from the storage section of the unit side into the storage section of the apparatus body side at prescribed time,
wherein the control section comprises:
a second information writing device for writing information from the storage section of the apparatus body side into the storage section of the unit side at prescribed time.

3. The image forming apparatus of claim 2,
wherein time when the first information writing device writes information into the storage section of the apparatus body side is when power supply to the apparatus body side starts or when the unit is mounted.

4. The image forming apparatus of claim 3,
wherein the information stored in the storage section of the apparatus body side includes information on a number of times of use for each part, and
wherein the control section determines whether the information on the number of times of use for each part has been reset or not, and if the information on the number of times of use has been reset, the control section controls the first information writing device to write the information on the number of times of use for each part, into the storage section of the apparatus body side.

5. The image forming apparatus of claim 2,
wherein time when the second information writing device writes information into the storage section of the unit side is, at least, time when power supply to the apparatus body side is cut off, when a prescribed number of sheets have been printed, when a unit replacement operation has been started, or when a life span of the part has expired.

6. The image forming apparatus of claim 1,
wherein the control section comprises:
a determination device which determines whether or not information should be written from a storage section of the unit side to the storage section of the apparatus body side, based on the identification information and the information on the number of times of use.

7. The image forming apparatus of claim 1,
wherein the control section comprises:
a memory selection device which selects from the plurality of memory areas having been set in the storage section, in association with the identification information of each of the function implementation unit.

8. The image forming apparatus of claim 7,
wherein the information stored in the storage section includes information on a replacement date of the function implementation unit, and
wherein the control section determines whether all the plurality of memory areas having been set in the storage section have been used or not, and whether the identification information of the function implementation unit, which is not present in any of the plurality of memory areas has been read or not, and based on a result of determination, the control section controls the memory selection device so as to select a memory area which stores information of the function implementation unit whose replacement date is oldest.

9. A control method of an image forming apparatus which allows replacement of a function implementation unit which is mounted on an apparatus body of the image forming apparatus and shares a load of implementing an image forming output function, the control method comprising the steps of
setting a plurality of memory areas for unit management in a memory area provided on the apparatus body; and
controlling writing of information into each function implementation unit using the plurality of memory areas having been set.

10. The control method of claim 9, further comprising:
first writing information from a storage section of a unit side to a storage section of an apparatus body side of the image forming apparatus at prescribed time; and
second writing information from the storage section of the apparatus body side to the storage section of the unit side at prescribed time.

11. The control method of claim 10,
wherein time at the first writing step is when power supply to the apparatus body side starts or when the unit is mounted.

12. The control method of claim 11,
wherein the information stored in the storage section of the apparatus body side includes information on a number of times of use for each part constituting the function implementation unit, and
wherein in the controlling step, whether information on the number of times of use for each part has been reset or not is determined and, if the information on the number of times of use has been reset, the first writing is controlled to write the information on the number of times of use for each part, into the storage section of the apparatus body side.

13. The control method of claim 10,
wherein time at the second writing is, at least, time when power supply to the apparatus body side is cut off, when a prescribed number of sheets has been printed, when a unit replacement operation has been started, or when a life span of the part has expired.

14. The control method of claim 9,
wherein the controlling step comprises:
determining whether or not information should be written from a storage section of a unit side to a storage section of a apparatus body side, based on identification information for identifying the function implementation unit and information on a number of times of use, including a number of times a part constituting the function implementation unit has been used.

15. The control method of claim 9,
wherein the controlling step comprises:
selecting from the plurality of memory areas having been set in the storage section, in association with the identification information of each of the function implementation unit.

16. The control method of claim 15,
wherein the information stored in the storage section includes information on a replacement date of the function implementation unit, and
wherein the control step further comprising:
determining whether all the plurality of memory areas having been set in the storage section have been used or not, and whether the identification information of the function implementation unit, which is not present in any of the plurality of memory areas has been read or not; and
selecting a memory area which stores information of the function implementation unit whose replacement date is oldest based on a result of determination.
